(19) United States
(12) Patent Application Publication
(10) Pub. No.: US 2008/0155872 A1
(43) Pub. Date: Jul. 3, 2008

(54) Vehicle Whip Flag Mounting Apparatus

(76) Inventor: Andrew J. Brengman, Spring Valley, CA (US)

Correspondence Address: ICE MILLER LLP, ONE AMERICAN SQUARE, SUITE 3100, INDIANAPOLIS, IN, 46282-0200, US

(21) Appl. No.: 11/965,330

(22) Filed: Dec. 27, 2007

Related U.S. Application Data
(60) Provisional application No. 60/877,520, filed on Dec. 28, 2006.

(51) Int. Cl. G09F 21/04

(52) U.S. Cl. 40/592

(57) ABSTRACT

An apparatus for mounting signaling articles to a vehicle. In an embodiment of the present disclosure, the apparatus comprises a plate comprising a first surface and a second surface; an expansion fitting comprising a first surface and a second surface, wherein the first surface of the expansion fitting is oriented toward the second surface of the plate and the expansion fitting comprises a flexible material; a securing bolt comprising a head and a threaded portion, the threaded portion being inserted through a hole in the plate and a hole in the expansion fitting; and an attachment nut wherein and end of the attachment nut is threadably engaged with the threaded portion of the securing bolt.

This application claims the benefit of U.S. Provisional Patent Application Ser. No. 60/877,520, filed Dec. 28, 2006, the disclosure of which is incorporated herein by reference.

### BACKGROUND

Safety flags are commonly used by many off-road vehicles as a means to warn others of the vehicle's presence. Due to the uneven terrain encountered by many vehicles driving off-road, the presence of a vehicle may be masked until a collision is unavoidable. This necessity is underscored by the requirement in many regions that safety (or “whip”) flags be displayed. For example, the U.S. Mine Safety and Health Administration mandates the use of whip flags under certain circumstances. Typically, whip flags are displayed on the top of whip masts which are normally eight to ten feet in length (but may be shorter or longer) and are attached to the vehicle. Whip flags may also contain light emitting sources for visualization during dark conditions.

The attachment of a whip flag and mast to vehicles is a problematic situation that must account for solid fixation of the mast to the vehicle, and sensitivity to preserving the painted exterior of the vehicle. Given that the site of attachment may undergo severe stress due to the size of the whip flag and mast and potential collisions of the flag and mast with external structures, the mounting apparatus must provide structural support. Additionally, the mounting of this device should not harm the vehicle and should be easily removable.

Due to the growing requirements for the display of signaling articles such as whip flags, and the challenges of mounting such articles to vehicles, there exists a significant need for an apparatus for securely mounting signaling articles such as whip flags to vehicles.

### SUMMARY

The present disclosure includes disclosure of apparatuses for mounting signaling articles to a vehicle. At least one embodiment of the present disclosure comprises disclosure of an apparatus comprising a plate that includes a hole, a first surface, and a second surface; an expansion fitting comprising a hole, a first surface, and a second surface, wherein the first surface of the expansion fitting may be oriented toward the second surface of the plate and the expansion fitting may be sized to fit within an attachment site of a vehicle, and wherein the expansion fitting may comprise a flexible material, whereby compression of the expansion fitting deforms the expansion fitting within the attachment site of the vehicle; a securing bolt comprising a head and a threaded portion, wherein the threaded portion may be inserted through the hole in the plate and through the hole in the expansion fitting; and an attachment nut comprising a first end and a second end, wherein the first end of the attachment nut may be threadably engaged with the threaded portion of the securing bolt. According to an aspect of at least one embodiment of the present disclosure, the second end of the attachment nut may be adapted to receive a signaling article, such as, for example, a whip flag.

According to an aspect of at least one embodiment of the present disclosure, apparatuses for restraining signaling articles on a vehicle may comprise a compression piece that includes a hole, a first surface, and a second surface. The threaded portion of a securing bolt may be inserted through the hole in the compression piece. The first surface of the compression piece may be oriented toward the second surface of an expansion fitting, and the second surface of the compression piece may be oriented toward the head of the securing bolt. According to an aspect of at least one embodiment of the present disclosure, the second surface of an expansion fitting may be contoured and the first surface of a compression piece may be contoured, wherein the contours of the second surface of the expansion fitting mate with the contours of the first surface of the compression piece. According to an aspect of at least one embodiment of the present disclosure, the second surface of an expansion fitting may be concave and the first surface of a compression piece may be convex, wherein the concave second surface of the expansion fitting mates with the convex first surface of the compression piece.

According to an aspect of at least one embodiment of the present disclosure, apparatuses for mounting signaling articles on a vehicle may comprise a protective mat constructed of a non-marring material and comprising a hole, wherein the threaded portion of a securing bolt may be inserted through the hole in the protective mat, and the protective mat may be arranged between the second surface of a plate and the first surface of an expansion fitting. According to an aspect of at least one embodiment of the present disclosure, apparatuses for restraining signaling articles on a vehicle may comprise a pressure dispersion element comprising a hole, wherein the threaded portion of a securing bolt may be inserted through the hole in the pressure dispersion element, and the pressure dispersion element may be arranged between the first end of an attachment nut and the first surface of a plate.

According to an aspect of at least one embodiment of the present disclosure, apparatuses for restraining signaling articles on a vehicle may comprise a electrical connector within an attachment nut, wherein the electrical connector may be accessible from an end of the attachment nut, and the electrical connector may be electrically connected to an electrical system of a vehicle. According to an aspect of at least one embodiment of the present disclosure, the electrical connector may be adapted to receive a signaling article comprising electrical wiring, such as, for example, a light emitting whip flag. According to an aspect of at least one embodiment of the present disclosure, a first end of a first electrical conductor may be electrically connected to the electrical connector, the second end of the first electrical conductor may be electrically connected to the electrical system of the vehicle. According to an aspect of at least one embodiment of the present disclosure, first electrical conductor extends through a longitudinal opening in a securing bolt. According to an aspect of at least one embodiment of the present disclosure, a first end of a second electrical conductor may be electrically connected to the securing bolt, the second end of the second electrical conductor may be electrically connected to the electrical system of the vehicle.

### BRIEF DESCRIPTION OF THE DRAWINGS

The features and advantages of this invention, and the manner of attaining them, will be more apparent and better understood by reference to the following descriptions of embodiments of the invention, taken in conjunction with the accompanying drawings, wherein:

FIG. 1A illustrates a partially cut away side elevation view of a whip flag mount apparatus according to at least one embodiment of the present disclosure.

FIG. 1B illustrates a cross-sectional view of a whip flag mount apparatus according to at least one embodiment of the present disclosure.

FIG. 2A illustrates a partially cut away side elevation view of a whip flag mount apparatus according to at least one embodiment of the present disclosure.

FIG. 2B illustrates a cross-sectional view of a whip flag mount apparatus according to at least one embodiment of the present disclosure.

FIG. 3 illustrates a side view of a whip flag mount apparatus according to at least one embodiment of the present disclosure.

FIG. 4 illustrates a bottom view of a whip flag mount apparatus according to at least one embodiment of the present disclosure.

FIG. 5 illustrates a top view of a whip flag mount apparatus according to at least one embodiment of the present disclosure.

FIG. 6A illustrates a bottom view of an expansion cup according to at least one embodiment of the present disclosure

FIG. 6B illustrates a top view of an expansion cup according to at least one embodiment of the present disclosure.

FIG. 6C illustrates a side view of an expansion cup according to at least one embodiment of the present disclosure.

FIG. 6D illustrates an end view of an expansion cup according to at least one embodiment of the present disclosure.

FIG. 7A illustrates a bottom view of a compression block according to at least one embodiment of the present disclosure.

FIG. 7B illustrates a top view of a compression block according to at least one embodiment of the present disclosure.

FIG. 7C illustrates a side view of a compression block according to at least one embodiment of the present disclosure.

FIG. 7D illustrates an end view of a compression block according to at least one embodiment of the present disclosure.

FIG. 8A illustrates a bottom view of an expansion cup and a compression block in engagement according to at least one embodiment of the present disclosure.

FIG. 8B illustrates a side view of an expansion cup and a compression block in engagement according to at least one embodiment of the present disclosure.

FIG. 9 illustrates a bottom perspective view of a whip flag mount apparatus comprising an electrical connector according to at least one embodiment of the present disclosure.

FIG. 10 illustrates a top perspective view of a whip flag mount apparatus comprising an electrical connector according to at least one embodiment of the present disclosure.

FIG. 11A illustrates a cross-sectional view of a whip flag mount apparatus comprising an electrical connector according to at least one embodiment of the present disclosure.

FIG. 11B illustrates a cross-sectional view of a whip flag mount apparatus comprising an electrical connector according to at least one embodiment of the present disclosure.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

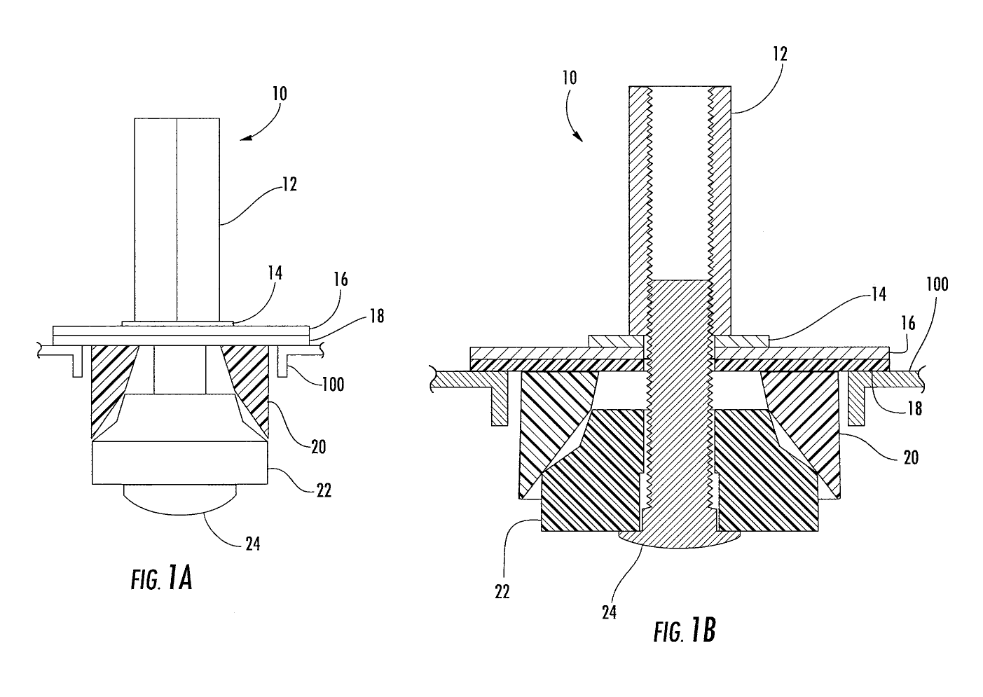

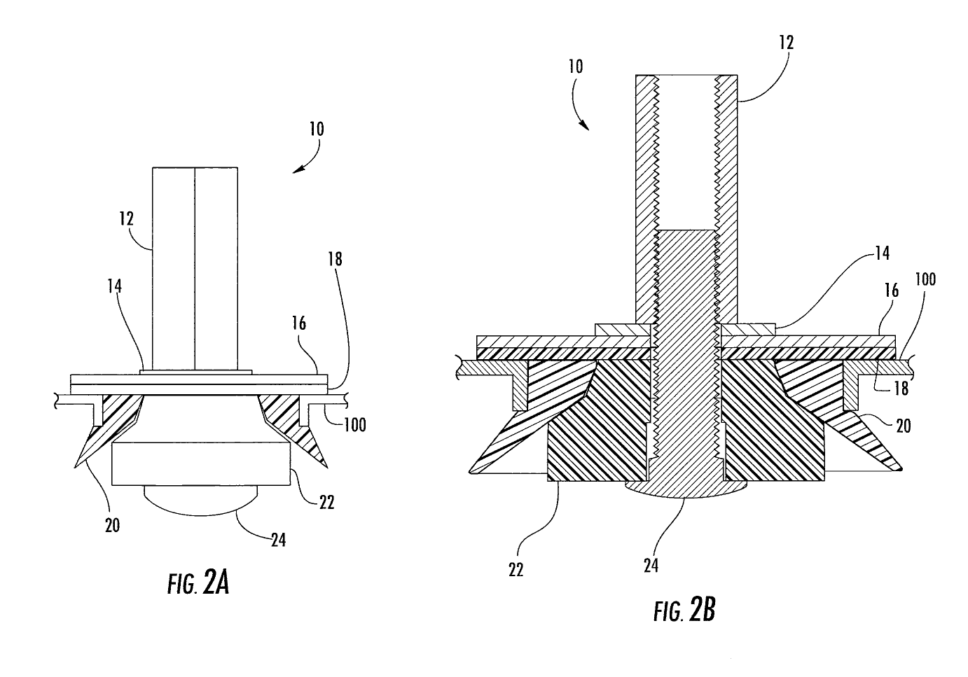

FIG. 1A shows a partially cut away side elevation view of a whip flag mount according to at least one embodiment of the present disclosure. FIG. 1B shows a cross sectional view of a whip flag mount according to at least one embodiment of the present disclosure. Shown in FIGS. 1A, 1B are whip flag mount 10 comprising coupling nut 12, washer 14, cover plate 16, mat 18, expansion cup 20, compression block 22, and bolt 24. Whip flag mount 10 is shown in FIGS. 1A, 1B installed in an aperture in truck bed 100, such as, for example a stake rack cutout in truck bed 100. For clarity, only the portion of truck bed 100 immediately adjacent to the aperture is shown in FIGS. 1A, 1B.

In at least one embodiment of the present disclosure, coupling nut 12 comprises an internally threaded coupling nut. In at least one embodiment of the present disclosure, coupling nut 12 has a first end, a second end, a hexagonal outer surface, and a hollow interior comprising internal threads. In at least one embodiment of the present disclosure, bolt 24 is a carriage bolt comprising external threads and an unthreaded, square carriage portion under a head. The external threads of bolt 24 mate with the internal threads of coupling nut 12. FIGS. 1A, 1B show bolt 24 inserted into the first end of coupling nut 12. As shown in FIGS. 1A, 1B, bolt 24 and coupling nut 12 are partially threadably engaged.

Although shown in embodiments of the present disclosure shown in FIGS. 1A, 1B, washer 14 is optional. Where used, washer 14 is sized to receive the threaded section of bolt 24.

In at least one embodiment of the present disclosure, cover plate 16 is constructed of steel, stainless steel, or other durable material. In at least one embodiment of the present disclosure, cover plate 16 is constructed of a corrosion-resistant material. Cover plate 16 is sized to be larger than the truck bed aperture in which whip flag mount 10 is installed. Cover plate 16 comprises a hole sized to receive the threaded portion of bolt 24 (or bolt 26 as discussed hereinafter).

In at least one embodiment of the present disclosure, mat 18 is constructed of a material designed to protect the surface of truck bed 100, such as rubber or a non-marring plastic material. In at least one embodiment of the present disclosure, mat 18 is of substantially the same size as cover plate 16. Mat 18 comprises a hole sized to receive the threaded portion of bolt 24 (or bolt 26 as discussed hereinafter). In at least one embodiment of the present disclosure, mat 18 is of a non-uniform thickness so as to account for the attachment to an uneven surface or a surface that is not parallel to the ground.

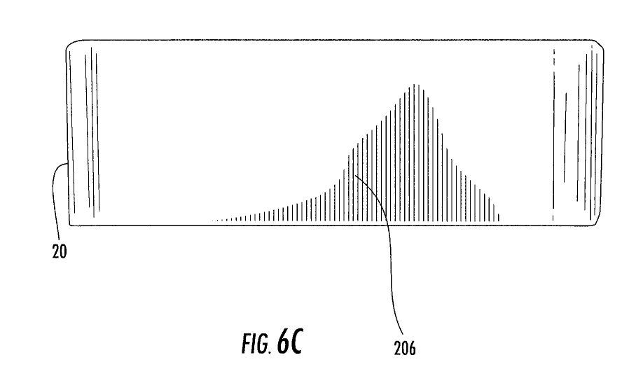

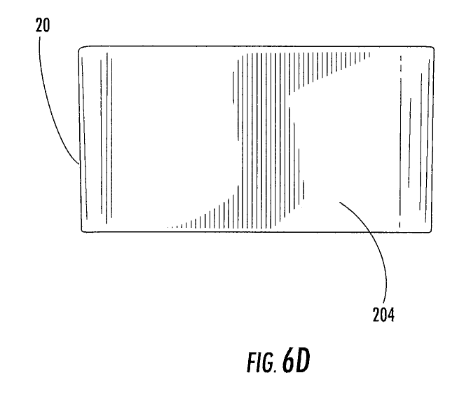

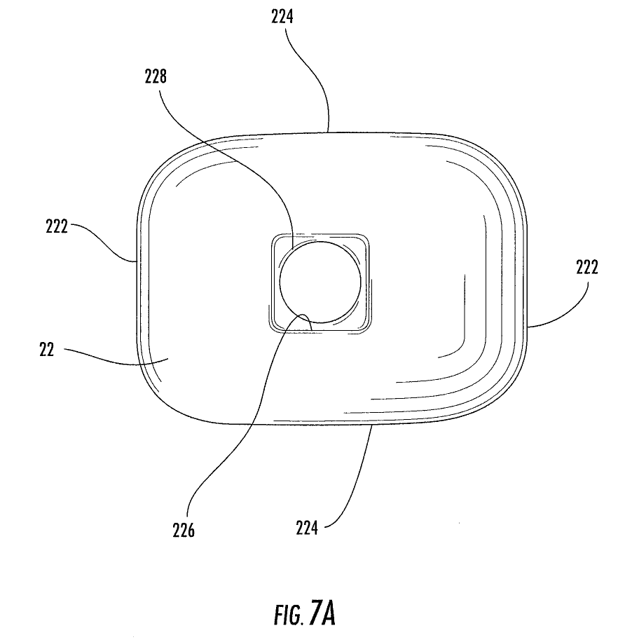

In at least one embodiment of the present disclosure, expansion cup 20 is constructed of a flexible material, such as natural rubber or SBR, or another plastic material having elastic properties. FIGS. 6A, 6B, 6C, 6D show views of at least one embodiment of expansion cup 20 according to the present disclosure. FIG. 6A shows a bottom view of expansion cup 20 according to at least one embodiment of the present disclosure. Shown in FIG. 6A are slits 202, end segments 204, side segments 206, and center hole 208. Slits 202 separate each end segment 204 from an adjacent side segment 206. In the embodiments shown in FIG. 6A, slits 202 permit end segments 204 and side segments 206 to flex outward when compressed by compression block 22, as discussed elsewhere herein. Slits 202 are optional. In at least one other embodiment of the present disclosure, expansion cup 20 contains no slits. In the embodiments of the present disclosure shown in FIG. 6A, each end segment 204 comprises an angled internal surface 214. Likewise, each side segment 206 comprises an angled internal surface 216.

FIG. 6B shows a top views of expansion cup 20 according to embodiments of the present disclosure. Shown in FIG. 6B are end segments 204, side segments 206, and center hole 208. FIG. 6C shows a side view of expansion cup 20, showing one side segment 206. FIG. 6D shows an end view of expansion cup 20, showing one end segment 204.

Referring back to FIGS. 1A, 1B, compression block 22 according to at least one embodiment of the present disclosure comprises a substantially inflexible material that will cause expansion cup 20 to flex when compression block 22 is forced against it. Compression block 22 may be constructed of any suitable material. In at least one embodiment of the present disclosure, compression block 22 is constructed of nylon.

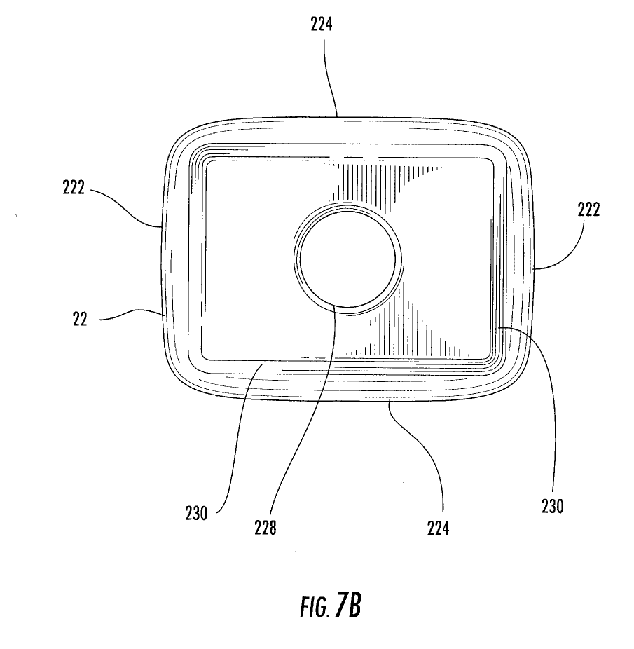

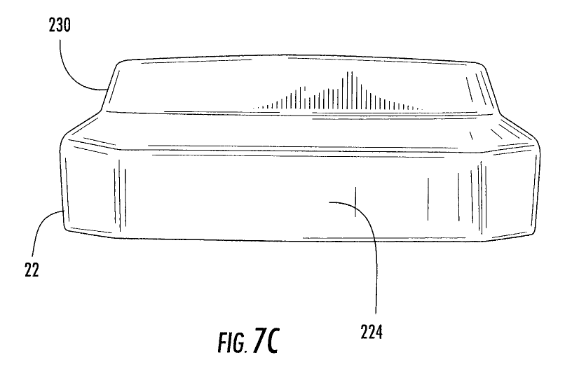

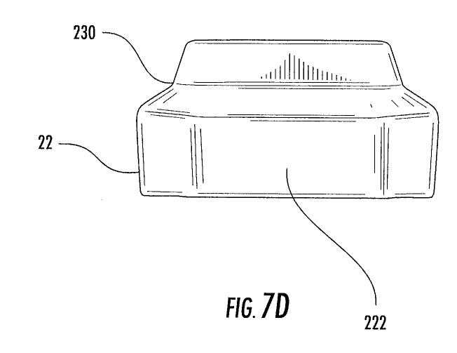

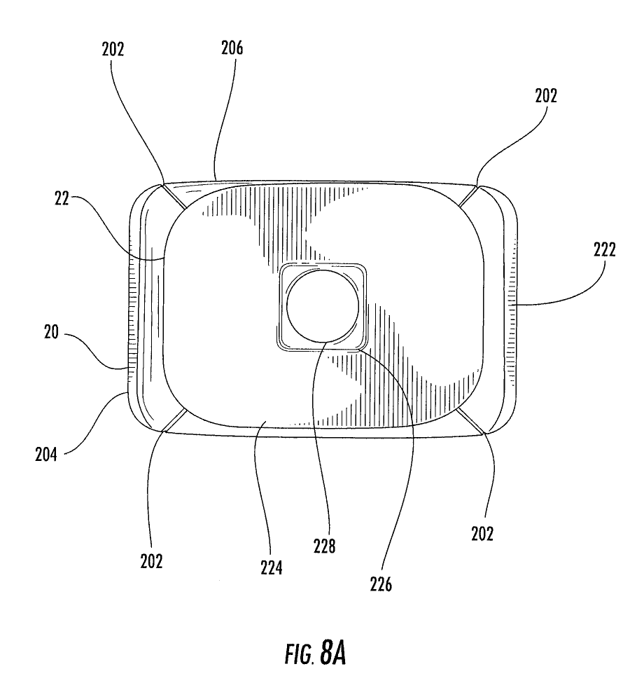

FIGS. 7A, 7B, 7C, 7D show compression block 22 according at least one embodiment of the present disclosure. Shown in FIGS. 7A is a bottom view of compression block 22. Shown in FIG. 7A are ends 222, sides 224, square aperture 226, and round aperture 228. Square aperture 226 is sized to receive the carriage portion of bolt 24 (or bolt 26 as discussed hereinafter). Round aperture 228 is sized to receive the threaded portion of bolt 24 (or bolt 26 as discussed hereinafter).

FIG. 7B shows a top view of compression block 22. Shown in FIG. 7B are sides 222, ends 224, round aperture 228, and tapered portion 230. Tapered portion 230 encompasses an outer surface of compression block 22.

FIG. 7C shows a side view of compression block 22. Shown in FIG. 7C are side 224 and tapered portion 230.

FIG. 7D shows an end view of compression block 22. Shown in FIG. 7D are end 222 and tapered portion 230.

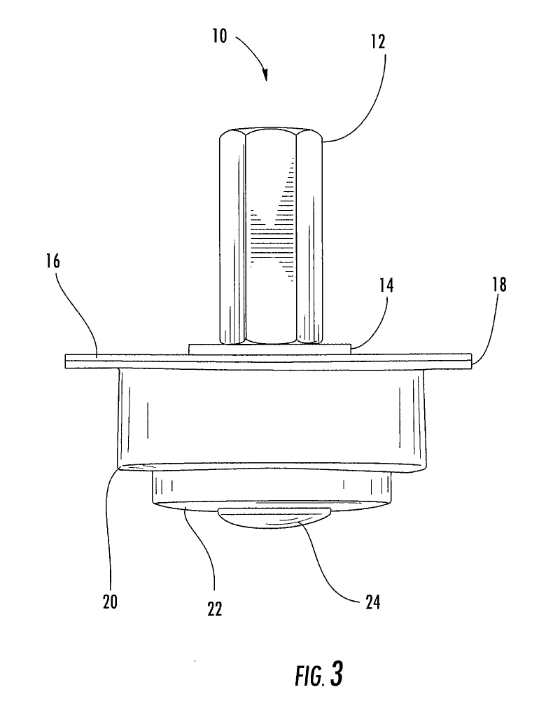

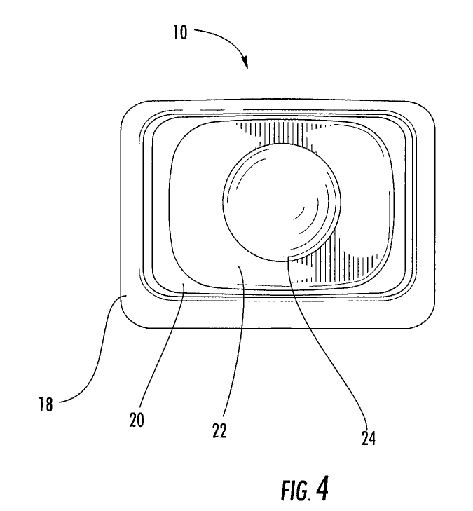

Referring now to FIG. 2A, there is shown a partially cut away side view of whip flag mount 10 according to at least one embodiment of the present disclosure when installed in truck bed 100. FIG. 2B shows a cross-sectional view of whip flag mount 10 according to at least one embodiment of the present disclosure when installed in truck bed 100. For clarity, only the portion of truck bed 100 immediately adjacent to the aperture is shown in FIGS. 2A, 2B. According to embodiments of the present disclosure, the user assembles whip flag mount 10 as shown in FIGS. 1A, 1B, and inserts the assembled whip flag mount 10 through an aperture in truck bed 100. A surface of mat 18 rests against a surface of truck bed 100. Bolt 24 is partially threadably engaged with coupling nut 12 to the extent that the components of whip flag mount 10 are held together, but not to the extent that expansion cup 20 is caused to flex outward significantly.

As shown in FIGS. 1B and 2B, bolt 24 is more completely threadably engaged with the first end of coupling nut 12 than was the case in FIGS. 1A and 2A, respectively. By tightening coupling nut 12, the head of bolt 24 is forced against the bottom surface of compression block 22. The engagement of the carriage portion of bolt 24 inside square aperture 226 of compression block 22 causes bolt 24 to resist rotating. Compression block 22 is forced against an inner surface of expansion cup 20. Tapered portion 230 of compression block 22 is forced against the angled inner surfaces 214 and 216 of end segments 204 and side segments 206, respectively, of expansion cup 20. End segments 204 and side segments 206 flex outward, separating at slits 202. Expansion cup 20 is thereby caused to flex outwardly against truck bed 100, securing whip flag mount 10 in place in the aperture of truck bed 100.

As noted elsewhere herein, slits 202 are optional. In at least one other embodiment of the present disclosure, expansion cup 20 contains no slits. In such an embodiment, end segments 204 and side segments 206 of expansion cup 20 flex outward when compression block 22 is forced against the angled inner surfaces of end segments 204 and side segments 206, but end segments 204 and side segments 206 do not separate. Expansion cup 20 is thereby caused to flex outwardly against truck bed 100, securing whip flag mount 10 in place in an aperture of truck bed 100.

In at least one embodiment of the present disclosure, after whip flag mount 10 is secured in place in an aperture of truck bed 100, a whip flag (not shown) may be installed into the second end of coupling nut 12. In at least one embodiment, such a whip flag (not shown) may be installed into the second end of coupling nut 12 by engaging an end of the whip flag with the internal threads of coupling nut 12.

In at least one embodiment of the present disclosure, round aperture 228 of compression block 22 is adapted to comprise internal threads, and the first end of coupling nut 12 is adapted to comprise an externally threaded member extending therefrom. In such an embodiment of the present disclosure, the externally threaded member extending from the first end of coupling nut 12 is inserted through optional washer 14, plate 16, and mat 18, and then is threadably engaged with the internal threads of round aperture 228 of compression block 22. In such an embodiment of the present disclosure, compression block 22 is pulled toward coupling nut 12 when coupling nut 12 is tightened. Compression block 22 is forced against an inner surface of expansion cup 20. Tapered portion 230 of compression block 22 is forced against the angled inner surfaces 214 and 216 of end segments 204 and side segments 206, respectively, of expansion cup 20. Expansion cup 20 is thereby caused to flex outwardly against truck bed 100, securing whip flag mount 10 in place in the aperture of truck bed 100.

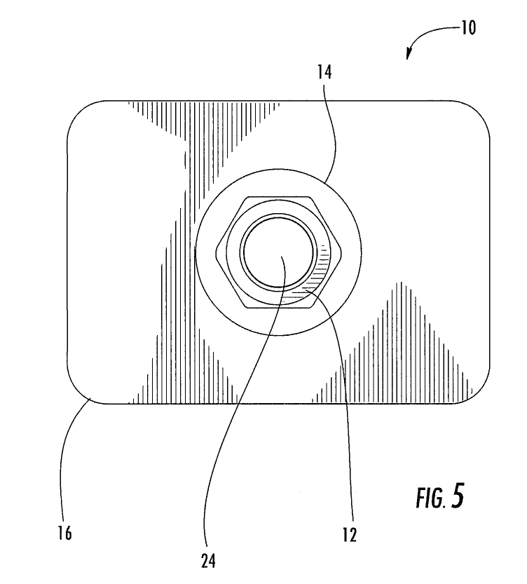

FIG. 3 shows a side elevation view of whip flag mount 10 according to embodiments of present disclosure. Visible in FIG. 3 is coupling nut 12, washer 14, cover plate 16, mat 18, expansion cup 20, compression block 22, and bolt 24.

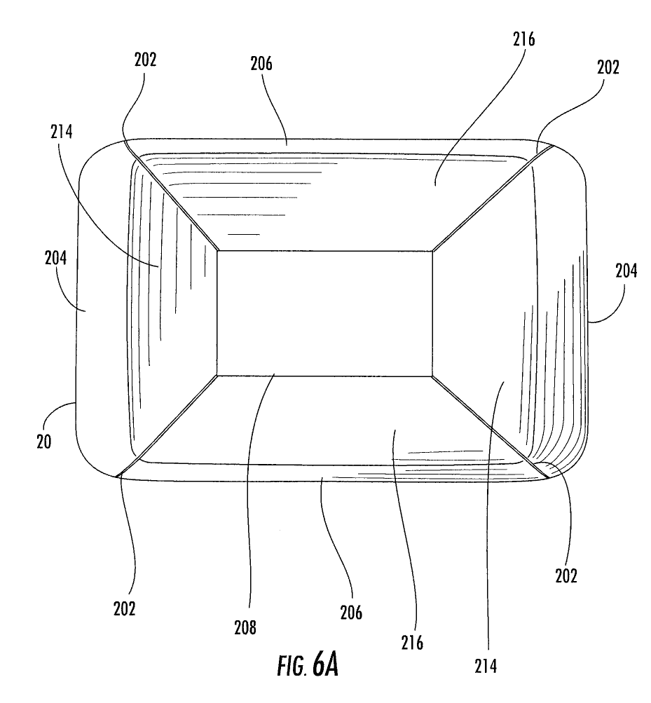

FIG. 4 shows a bottom view of whip flag mount 10 according to embodiments of present disclosure. Visible in FIG. 4 are mat 18, expansion cup 20, compression block 22, and bolt 24.

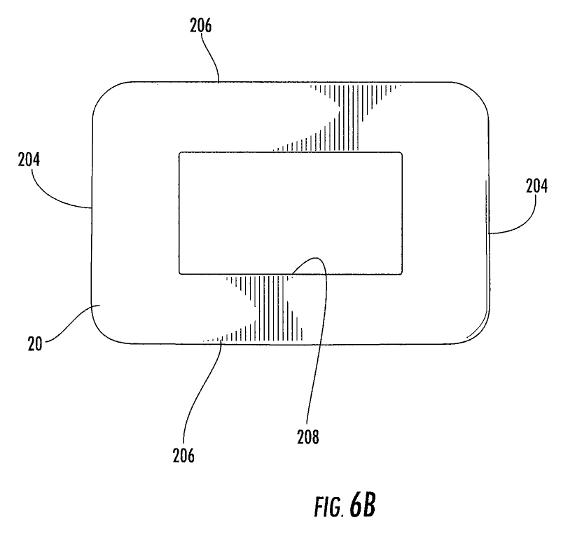

FIG. 5 shows a top views of whip flag mount 10 according to embodiments of the present disclosure. Shown in FIG. 5 are coupling nut 12, washer 14, bolt 24, and plate 16.

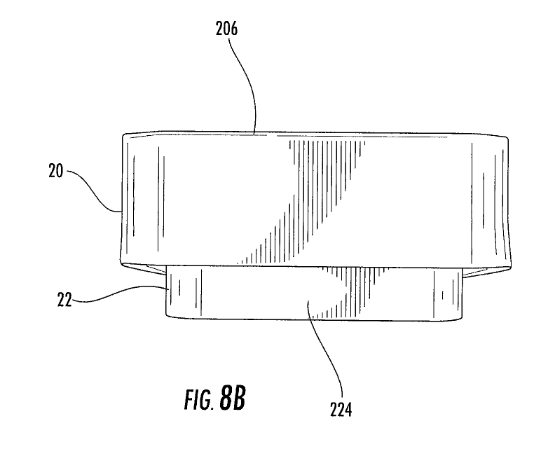

FIG. 8A shows a bottom view of expansion cup 20 and compression block 22 in engagement according to at least one embodiment of the present disclosure. Coupling nut 12, washer 14, cover plate 16, mat 18, and bolt 24 are omitted from this view.

FIG. 8B shows a side view of expansion cup 20 and compression block 22 in engagement according to at least one embodiment of the present disclosure. Coupling nut 12, washer 14, cover plate 16, mat 18, and bolt 24 are omitted from this view.

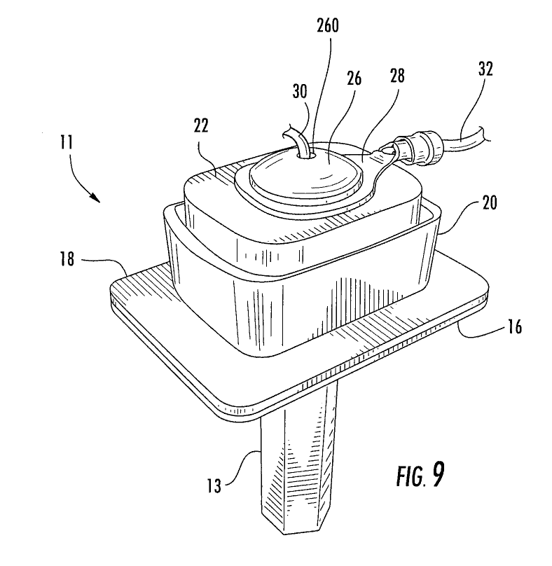

FIG. 9 shows a bottom perspective view of electrical whip flag mount 11 according to at least one embodiment of the present disclosure. Shown in FIG. 9 are coupling nut 13, cover plate 16, mat 18, expansion cup 20, compression block 22, bolt 26 comprising opening 260, ground terminal 28, power lead 30, and ground lead 32.

In at least one embodiment of the present disclosure, power lead 30 comprises an insulated electrical conductor. As shown in FIG. 9, power lead 30 is fed through opening 260 in bolt 26. Power lead 30 is electrically insulated from bolt 26.

In at least one embodiment of the present disclosure, ground lead 32 comprises an insulated electrical conductor. Ground terminal 28 is mechanically and electrically connected to a first end of ground lead 32 such as by crimping, soldering, or another manner of making a mechanical and electrical connection between a wire and terminal. In at least one embodiment of the present disclosure, ground terminal 28 comprises a ring terminal, however other types of electrical terminals may be used and are within the scope of the present disclosure. In at least one embodiment of the present disclosure, a second end of ground lead 32 (not shown) is electrically connected to the electrical ground of the vehicle which whip flag mount 11 is installed.

In at least one embodiment of the present disclosure, ground terminal 28 is secured between compression block 22 and bolt 26. Bolt 26 and ground terminal 28 are in contact, and there is an electrical connection therebetween.

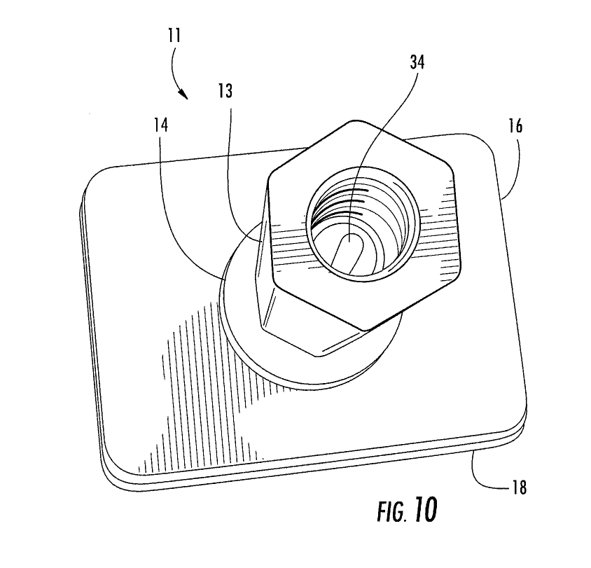

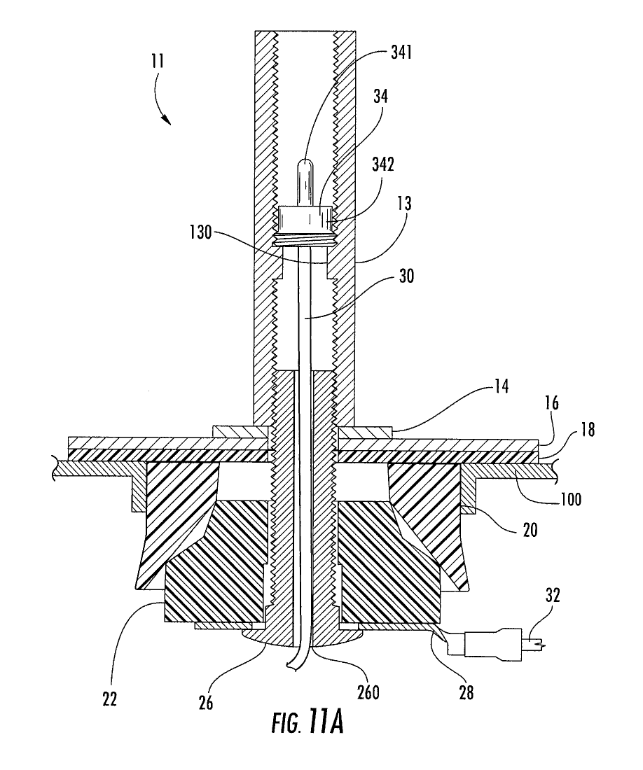

FIG. 10 shows a top perspective view of electrical whip flag mount 11 according to at least one embodiment of the present disclosure. Shown in FIG. 10 are coupling nut 13, optional washer 14, plate 16, mat 18, and connector 34.

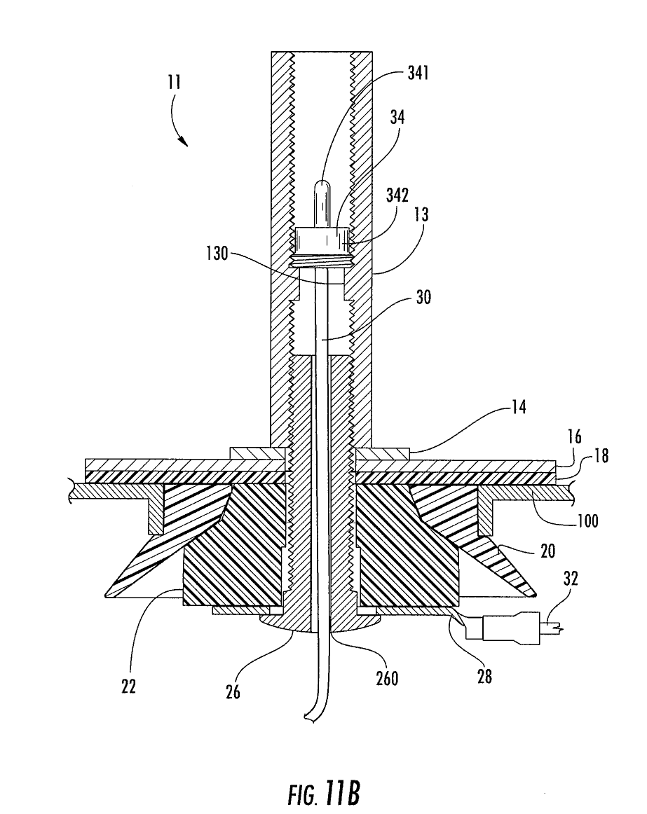

FIG. 11A shows a cross-sectional view of electrical whip flag mount 11 according to at least one embodiment of the present disclosure. Shown in FIG. 11A are coupling nut 13 comprising shelf 130, optional washer 14, plate 16, mat 18, expansion cup 20, compression block 22, bolt 26, opening 260, ground lead 28, power lead 30, ground terminal 32, connector 34, center pin 341, and shield 342.

In at least one embodiment of the present disclosure, coupling nut 13 comprises an internally threaded coupling nut. In at least one embodiment of the present disclosure, coupling nut 13 has a first end, a second end, a hexagonal outer surface, a hollow interior comprising internal threads, and an internal shelf 130 comprising no threads. In at least one embodiment of the present disclosure, the first end of coupling nut 13 is adapted to threadably mate with bolt 26, and the second end of coupling nut 13 is adapted to receive a signaling article such as a whip flag (not shown). In at least one embodiment of the present disclosure, the internal threads of the first end of coupling nut 13 and the internal threads of the second end of coupling nut 13 are different.

In at least one embodiment of the present disclosure, bolt 26 is a carriage bolt comprising external threads and an unthreaded, square carriage portion under a head. The external threads of bolt 26 mate with the internal threads of the first end of coupling nut 13. Bolt 26 comprises opening 260 that extends longitudinally through bolt 26. Opening 260 is sized to accommodate power lead 30. FIG. 11A shows bolt 26 inserted into the first end of coupling nut 13. As shown in FIG. 11A, bolt 26 and coupling nut 13 are partially threadably engaged.

In at least one embodiment of the present disclosure, connector 34 comprises an RCA connector, however other types of electrical connectors may be used and are within the scope of the present disclosure. As shown in FIG. 11A, connector 34 is mechanically and electrically connected to power lead 30, such as by crimping, soldering, or another manner of making a mechanical and electrical connection between a wire and a connector. A first end of power lead 30 terminates in center pin 341 of connector 34. In at least one embodiment of the present disclosure, a second end of power lead 30 (not shown) is electrically connected to the electrical system of the vehicle in which whip flag mount 11 is installed. For example, the second end of power lead 30 (not shown) may be connected to the vehicle's electrical system in the vehicle's tail light assembly.

In the embodiment of the present disclosure shown in FIG. 11A, connector 34 is installed in the second end of coupling nut 13 such that connector 34 is in contact with shelf 130. In at least one embodiment of the present disclosure, connector 34 is threadably engaged with the internal threads of the second end of coupling nut 13 until connector 34 is in contact with shelf 130. In at least one embodiment of the present disclosure, connector 34 is pressed into the second end of coupling nut 13 until connector 34 is in contact with shelf 130.

As shown in the embodiment of the present disclosure shown in FIG. 11A, shield 342 of connector 34 is in contact with coupling nut 13, and there is an electrical connection therebetween. Coupling nut 13 is in contact with bolt 26, and there is an electrical connection therebetween. Shield 342 is electrically connected to the vehicle's electrical ground through the electrical connections between coupling nut 13, bolt 26, ground terminal 28, and ground lead 32.

FIG. 11B shows a cross-sectional view of whip flag mount 11 according to at least one embodiment of the present disclosure when installed in an aperture in truck bed 100. For clarity, only the portion of truck bed 100 immediately adjacent to the aperture is shown in FIG. 11B. According to at least one embodiment of the present disclosure, whip flag mount 11 is assembled as shown in FIG. 11A, and the assembled whip flag mount 11 is inserted through an aperture in truck bed 100. A surface of mat 18 rests against a surface of truck bed 100. Bolt 26 is partially threadably engaged with coupling nut 13 to the extent that the components of whip flag mount 10 are held together, but not to the extent that expansion cup 20 is caused to flex outward significantly.

As shown in FIG. 11B, bolt 26 is more completely threadably engaged with the first end of coupling nut 13 than was the case in FIG. 11A. By tightening coupling nut 13, the head of bolt 26 is forced against the bottom surface of compression block 22. Compression block 22 is forced against an inner surface of expansion cup 20. Expansion cup 20 is thereby caused to flex outwardly against truck bed 100, securing whip flag mount 11 in place in the aperture of truck bed 100.

In at least one embodiment of the present disclosure, after whip flag mount 11 is secured in place in an aperture of truck bed 100, a whip flag (not shown) may be installed into the second end of coupling nut 13. In at least one embodiment, such a whip flag (not shown) may be installed into the second end of coupling nut 13 by engaging an end of the whip flag with the internal threads of coupling nut 13. In at least one embodiment of the present disclosure, such a whip flag comprises electrical circuitry, such as for a light emitting source. A connector on the end of such a whip flag (not shown) that is engaged with the internal threads of coupling nut 13, may comprise a connector (not shown) adapted to mate with connector 34, thereby supplying electricity to the whip flag. Engagement of a whip flag (not shown) with the internal threads of coupling nut 13 may apply pressure on connector 34, thereby forcing connector against shelf 130 to enhance the electrical connection therebetween.

While this disclosure has been described as having preferred designs, the apparatus and methods according to the present disclosure can be further modified within the scope and spirit of this disclosure. This application is therefore intended to cover any variations, uses, or adaptations of the disclosure using its general principles. For example, any methods disclosed herein and in the appended claims represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. An apparatus for mounting a signaling article to a vehicle, the apparatus comprising:
a plate comprising a hole, a first surface, and a second surface, said plate being of a size larger than an attachment site on a vehicle;
an expansion fitting comprising a hole, a first surface, and a second surface, said first surface of said expansion fitting being oriented toward said second surface of said plate, said expansion fitting being sized to fit within said attachment site of said vehicle, said expansion fitting comprising a flexible material, whereby compression of said expansion fitting deforms said expansion fitting within said attachment site of said vehicle;
a securing bolt comprising a head and a threaded portion, said threaded portion being inserted through said hole in said plate and through said hole in said expansion fitting; and
an attachment nut, said attachment nut comprising a first end and a second end, wherein said first end of said attachment nut is threadably engaged with said threaded portion of said securing bolt.

2. The apparatus of claim 1, further comprising:
a compression piece, said compression piece comprising a hole, a first surface, and a second surface, said threaded portion of said securing bolt being inserted through said hole in said compression piece, said first surface of said compression piece being oriented toward said second surface of said expansion fitting, said second surface of said compression piece being oriented toward said head of said securing bolt.

3. The apparatus of claim 2, wherein said second surface of said expansion fitting is contoured and said first surface of said compression piece is contoured, and wherein said contours of said second surface of said expansion fitting mate with said contours of said first surface of said compression piece.

4. The apparatus of claim 2, wherein said second surface of said expansion fitting is concave and said first surface of said compression piece is convex, and wherein said concave second surface of said expansion fitting mates with said convex first surface of said compression piece.

5. The apparatus of claim 1, further comprising:
a protective mat, said protective mat constructed of a non-marring material and comprising a hole, said threaded portion of said securing bolt being inserted through said hole in said protective mat, said protective mat being arranged between said second surface of said plate and said first surface of said expansion fitting.

6. The apparatus of claim 1, further comprising:
a pressure dispersion element comprising a hole, said threaded portion of said securing bolt being inserted through said hole in said pressure dispersion element, said pressure dispersion element arranged between said first end of said attachment nut and said first surface of said plate.

7. The apparatus of claim 1, wherein said second end of said attachment nut is adapted to receive a signaling article.

8. The apparatus of claim 7, wherein said signaling article is a whip flag.

9. The apparatus of claim 1, further comprising:
a electrical connector within said attachment nut, said electrical connector being accessible from said second end of said attachment nut, said electrical connector being electrically connected to an electrical system of said vehicle.

10. The apparatus of claim 9, further comprising:
a first electrical conductor, said first electrical conductor having a first end and a second end, said first end of said first electrical conductor being electrically connected to said electrical connector, said second end of said first electrical conductor being electrically connected to said electrical system of said vehicle.

11. The apparatus of claim 10, wherein said first electrical conductor comprises electrically conductive material surrounded by insulating material, and wherein said first electrical conductor extends through a longitudinal opening in said securing bolt.

12. The apparatus of claim 10, further comprising:
a second electrical conductor, said second electrical conductor having a first end and a second end, said first end of said second electrical conductor being electrically connected to said securing bolt, said second end of said second electrical conductor being electrically connected to said electrical system of said vehicle.

13. The apparatus of claim 9, wherein said electrical connector is adapted to receive a signaling article comprising electrical wiring.

14. The apparatus of claim 12, wherein said signaling article is a light emitting whip flag.

15. An apparatus for restraining signaling articles on a vehicle, the apparatus comprising:
a plate comprising a hole, a first surface, and a second surface, said plate being of a size larger than an attachment site on a vehicle;
an expansion fitting comprising a hole, a first surface, and a second surface, said first surface of said expansion fitting being oriented toward said second surface of said plate, said expansion fitting being sized to fit within said attachment site of said vehicle, said expansion fitting comprising a flexible material, whereby compression of said expansion fitting deforms said expansion fitting within said attachment site of said vehicle;
a compression piece comprising a hole, a first surface, and a second surface, said first surface of said compression piece being oriented toward said second surface of said expansion fitting, said second surface of said compression piece being oriented toward said head of said securing bolt;
a protective mat, said protective mat constructed of a non-marring material and comprising a hole, said protective mat being arranged between said second surface of said plate and said first surface of said expansion fitting; and
a securing bolt comprising a head and a threaded portion, said threaded portion being inserted through said hole in said compression piece, through said hole in said expansion fitting, through said hole in said protective mat, and through said hole in said plate; and
an attachment nut, said attachment nut comprising a first end and a second end, wherein said first end of said attachment nut is threadably engaged with said threaded portion of said securing bolt, and said second end of said attachment nut is adapted to receive a signaling article.

16. An apparatus for restraining signaling articles on a vehicle, the apparatus comprising:
a plate comprising a hole, a first surface, and a second surface, said plate being of a size larger than an attachment site on a vehicle;
an expansion fitting comprising a hole, a first surface, and a second surface, said first surface of said expansion fitting being oriented toward said second surface of said plate, said expansion fitting being sized to fit within said attachment site of said vehicle, said expansion fitting comprising a flexible material, whereby compression of said expansion fitting deforms said expansion fitting within said attachment site of said vehicle;
a compression piece comprising a hole, a first surface, and a second surface, said first surface of said compression piece being oriented toward said second surface of said expansion fitting, said second surface of said compression piece being oriented toward said head of said securing bolt;
a protective mat, said protective mat constructed of a non-marring material and comprising a hole, said protective mat being arranged between said second surface of said plate and said first surface of said expansion fitting; and
a securing bolt comprising a head and a threaded portion, said threaded portion being inserted through said hole in said compression piece, through said hole in said expansion fitting, through said hole in said protective mat, and through said hole in said plate;
an attachment nut, said attachment nut comprising a first end and a second end, wherein said first end of said attachment nut is threadably engaged with said threaded portion of said securing bolt, and said second end of said attachment nut is adapted to receive a signaling article; and
a electrical connector within said attachment nut, said electrical connector being accessible from said second end of said attachment nut, said electrical connector being electrically connected to an electrical system of said vehicle.
